(19) United States
(12) Patent Application Publication
(10) Pub. No.: US 2025/0252377 A1
(43) Pub. Date: Aug. 7, 2025

(54) AUTOMATED EMPLOYEE TRAINING SYSTEM

(71) Applicant: IC Labs, LLC, Pasadena, CA (US)

(72) Inventors: Christopher McDaniel, Pasadena, CA (US); Brian Faulkner, Pasadena, CA (US); Michael Kakehashi, Pasadena, CA (US); Lynn Phillips, Pasadena, CA (US); John Kleeman, Pasadena, CA (US)

(21) Appl. No.: 19/047,237

(22) Filed: Feb. 6, 2025

Related U.S. Application Data
(60) Provisional application No. 63/551,002, filed on Feb. 7, 2024.

(51) Int. Cl. G06Q 10/0633; G06Q 50/20; G06Q 50/26

(52) U.S. Cl. CPC G06Q 10/0633; G06Q 50/2057; G06Q 50/265

(57) ABSTRACT

Aspects of the present disclosure relate to systems and methods for generating and providing training instructions. Specifically, aspects of the present disclosure relate to a network service that dynamically generates training instructions The network service can generate the training instructions based on a set of inputs generated from each computing device, employees' profile information, dynamically changed working environments, and/or sensor data received from a plurality of sensors deployed at the workspace. The network service can provide potential answers, having a data range to score each answer provided by the employees. The network service can also generate the training instructions sequentially or in random order. In addition, these training instructions can be provided once or recurrently. The network service can also utilize machine learning model to automatically generate the training instructions. The network service can also score each employee's answers and store them as a portion of the employee's profile.

This application claims the benefit of U.S. Provisional Patent Application No. 63/551,002, titled “AUTOMATIC EMPLOYEE TRAINING SYSTEM” filed on Feb. 7, 2024, which is hereby incorporated by reference in its entirety.

### BACKGROUND

Generally described, business administrators can manage workflow resources to operate the business more efficiently. The workflow resources can generally refer to human resources. Specifically, managing the workflow resources can include providing written instructions to individual employees and training the employees according to training instructions. For example, in the context of security monitoring embodiments, a security patrol service provider, such as the business administrator, may develop an overall patrol strategy according to contract parameters and client preference. The business administrator can then delegate responsibilities to patrol officers to implement the patrol strategy. The service provider could manage the patrol officers by providing one or more instructions to each officer during the execution of their duties and also one or more training to each officer based on the instructions provided for each officer.

As also generally described, computing devices and communication networks can be utilized to exchange data and/or information. In a common application, a computing device can request content from another computing device via the communication network. For example, a computing device can collect various data and utilize a software application to exchange content with a server computing device via the network (e.g., the Internet). Such software applications can include general communication applications for accessing the network, such as browser applications. Such general communication applications can access functionality provided by network-based services. The software applications can also include custom or specialized software applications configured to implement specific functionality alone or in combination with network-based services.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 depicts a block diagram of a system that includes one or more computing devices, sensors, and a network service provider according to one or more embodiments as disclosed herein;

FIG. 2 is a block diagram of illustrative components of a network service provider according to one or more embodiments as disclosed herein;

FIG. 3 is an illustrative interaction of generating and providing training instructions that can be utilized in the aspects of an automated training service in one or more embodiments as disclosed herein; and

FIG. 4 is a flow diagram illustrative of a routine for training employees by generating training instructions utilizing the network service provider.

### DETAILED DESCRIPTION

In the following description, various examples will be described. For purposes of explanation, specific configurations, and details are set forth in order to provide a thorough understanding of the examples. However, it will also be apparent to one skilled in the art that the examples may be practiced without specific details. Furthermore, well-known features may be omitted or simplified in order not to obscure the examples being described.

Generally described, aspects of the present disclosure relate to systems and methods for dynamically generating instructions as part of the execution of workflows. Specifically, aspects of the present disclosure relate to a network service that dynamically generates instructions for individuals (or sets of individuals) and provides the determined instructions prior to, or as part, execution of duties. The network service can determine the instructions based on a master plan and personal profile (e.g., personal attributes) for each employee. The network service can also generate instructions for each employee based on environmental inputs while executing workflow (e.g., execution of one or more tasks). For example, the network service can utilize sensor data received from a plurality of sensors deployed at the workspace. In some illustrations, a security service provider may generate a master plan based on their security patrol contracts. Based on this master plan, one or more patrol officers can be assigned for each patrol shift. In these illustrations, the security service provider can generate training instructions based on the assigned duty of each patrol officer. The security service provider can also further utilize the personal profile of each patrol officer to modify or add more training instructions. In addition, a plurality of sensors, such as motion detection sensors, audio record sensors, cameras, etc., can be deployed in the security patrol areas. In this example, the security service provider can receive the information generated from each sensor and process the received information to modify or add additional training instructions. In various embodiments, the security service provider may provide these training instructions to each security patrol officer via wireless communication to a mobile device, visual indications broadcast to the security patrol officer, audible instructions broadcast to the security patrol officer, and the like.

Illustratively, one or more aspects of the present application correspond to implementation in computer networks in which a plurality of computing devices has been configured in a manner that these computing devices exchange information with a network service provider via the computer networks, such as the wireless network. By way of illustrative example, the plurality of computing devices can correspond to electronic devices utilized by employees who are executing their duties. For example, the employee can utilize their computing device to receive training instructions from the network service provider and also to provide information, such as any reports, while executing their duty. In some examples, such computing devices can provide their current location information to the network service provider in real time or near real time. In some illustrated examples, the computing device can be configured to implement one or more functionalities to facilitate the employees' performance of their duties. For example, the computing device can be utilized by a security patrol officer, and the officer can utilize the camera functions of the computing device to scan the patrol area. Also, the officer can utilize the communication functions of the computing device to communicate with other patrol officers, supervisors, and the network service provider. These functions can be implemented based on specific applications, and the present disclosure does not limit any type of functionality.

In accordance with one or more implementations, a plurality of sensors or one or more sensors can be deployed within the workspace. The sensors can, in some embodiments, correspond to stand-alone devices or components that are configured (at least in part) specifically to provide information. For example, a stand-alone temperature sensor configured to measure, collect or generative information regarding environmental conditions. In other embodiments, the sensors can correspond to integrated or combination devices that may be utilized to generate sensor data but may have additional or alternative functionality not specifically configured to provide information. For example, a heating unit that may utilize temperature-based controls for operation and that operational information can be processed to generate environmental condition information. The types of deployed sensors can be determined based on the types of tasks executed in a workflow. In some illustrative embodiments, each of the plurality of sensors may transmit data that is received by the network service provider. The network service provider can process the received data by analyzing attributes included in the data. For example, motion sensors, temperature sensors, and noise sensors can be implemented in a security patrol area, and the network service provider can receive data from these sensors in real time. In this example, the network service provider can process the received data and generate or modify the training instructions. For instance, the network service provider may determine unexpected movement or noise at a patrol area, and the network service provider can generate instructions, such as a question that “what is a protocol when you detect an unexpected person in this patrol area?” After the patrol officer provides a correct answer, the network service provider can allow the security officer to perform the duty.

In accordance with one or more aspects of the present disclosure, the network service provider can implement one or more machine learned models. Illustratively, machine learned models can be configured to generate output in the form of instructions by monitoring data received from the plurality of sensors and/or the computing devices. For example, a machine learned model can be trained to generate instructions for the employees to perform their duties more efficiently. By way of illustration, the machine learned model can incorporate one or more aspects of a large language model (LLM) in which outputs generated can correspond to structured outputs, such as text, images, and a combination thereof. Specifically, in some embodiments, machine learned models can be configured to generate training instructions by curating data related to the duties and personal profile of each employee. The machine learned models may generate the training instructions and provide weight for each training instruction. For example, the machine learned models may weight each training instruction based on the priority of the instructions.

In some embodiments, the machine learned models can modify the training instructions based on the profile information of each employee and/or the working environments. For example, the machine learned models can modify or add additional training instructions based on the profile information of each employee. The profile of the employee can relate to each employee's attribute for performing the duty and can include but are not limited to rank (and associated duty), skills, performance history when executing the duty, previous evaluation data, training history of the employees, and the like. In some embodiments, the machine learned models can modify the training instructions based on the profile information of the working environment of each employee. The working environment can include one or more attributes related to the working environment. These attributes can include but are not limited to assigned duties in the environment, required skills, and the like. In some examples, these attributes can be updated by processing data received from various sensors deployed in the workplace. For example, a patrol service provider can receive sensor data from the sensors deployed in the target patrol areas, and the machine learned models utilized by the patrol service provider can generate the training data based on the processing results of the sensor data.

In general, traditionally, an employer provides training instructions to employees before the employees execute their duties to ensure that the employees know the orders of their duties. These instructions are provided manually, such that the training instructions are provided based on the required duties for each employee. For instance, the employer can have a database that includes training data determined based on employees' duties. Illustratively, when the duties are assigned to the employees, training instructions can be provided to each employee. The employee may complete the training instructions prior to executing their duties. However, in this conventional system for manually providing the training instructions, these training instructions were already created based on the required employees' duties. For example, a patrol service provider may generate the training instructions based on required patrol service requirements for each targeted patrol area. In this example, the generated instructions can be provided to the patrol officers assigned to the targeted patrol area. Thus, the training instructions are static and cannot be dynamically updated. This limitation can lead to inefficiencies and constraints in training the officers. For example, a security patrol officer might receive a static training instruction generated based only on the required patrol service. However, if the environment of the targeted patrol area is dynamically changed, such that one of the sensors deployed in the targeted patrol area detected a broken window at the base of the building, the current officer would still receive the same training instructions (e.g., general training instruction) to perform the patrol duty. Thus, the patrol officer may not receive training instruction related to a scenario that identified the broken window. This can lead to inefficiencies by not receiving the training instruction adapted to the dynamically changed environment. In addition, the traditional training instructions are provided to the employees regardless of each employee's skills. For example, a security officer certified for the use of a firearm and other patrol officers who are not certified for use of the firearm may receive the same training instructions. These can result in management inefficiencies for the security service provider. Moreover, it might be challenging for the security service provider's management to monitor whether each security officer has diligently completed the training instructions.

To address at least a portion of the deficiencies described above, one or more aspects of the present disclosure relate to systems and methods for providing training instructions by dynamically adapting to the current environment and also each employee's attributes. Specifically, these systems and methods can dynamically generate training instructions based on each employee's required duty, profile (e.g., attributes), and working environment profile (e.g., working environment attributes). In some embodiments, the training instructions are generated by utilizing data generated from computing devices and/or one or more sensors associated with the work environment. Illustratively, a network service provider can implement an automated training service. According to one or more embodiments, as disclosed herein, the automated training service may dynamically generate training instructions and provide the generated training instructions to each employee prior to the employees initiating their duty.

In various embodiments, the automated training service can monitor whether the employees are prepared to initiate their work duties. In some cases, the automated training service can receive input from the computing device utilized by each employee, where the input indicates that the employee is willing to initiate work duty. In some examples, the employee, by utilizing the computing device, can initiate check in (e.g., clock in) function, and the automated training service can receive the initiated check in from the computing device.

In some embodiments, the automated training service can monitor the location of the employees and determine whether the employees are within the physical range of performing their assigned duties and prepared for performing the duties. For example, the automated training service implemented by a security patrol service provider may monitor the location of the security patrol officers and determine whether these officers are within a post associated with their patrol duty. In some examples, the automated training service can automatically determine the training instructions in response to determining that the patrol officers are within a range of their assigned patrol area. For example, the automated training service may transmit the instructions to the computing device utilized by the individual patrol officer.

In some embodiments, the automated training service provides the training instructions as questions based on various scenarios (or campaigns) related to the duties. For example, the automated training service can determine questions based on security patrol orders for each post and one or more scenarios related to the patrol service. In various examples, the patrol officer may answer these training instructions (e.g., questions) prior to initiating their patrol duties. In some cases, the automated training service provides the training scenarios with acceptable answers (or a range of acceptable answers). In some examples, these training scenarios can be provided in a certain sequence or randomly. In some cases, these training scenarios can be provided once or recurrently.

In various examples, the automated training service may analyze an employee's workflow and generate training instructions by identifying the employee's required duty. The automated training service can further process these generated training instructions based on the employee's profile. The profile can include attributes related to the employee, such as rank (and associated duty), skills, performance history when executing the duty, previous evaluation data, training history of the employees, and the like. For example, the training instructions are modified based on the rank of the employee and/or the skills of the employee. Furthermore, the training instructions can be modified based on historical performance or evaluation records of the employee. For instance, if the employee, a security patrol officer, previously did not perform a specific duty (or did not meet established service levels), the training instructions can be tailored to this scenario. In another example, if the patrol officer has a special skill, such as a specification of using a type of gun, the training instruction can be related to this special skill. Thus, the automated training service can modify or generate additional training instructions based on an individual employee's profile or attributes, and the present disclosure does not limit these attributes.

In some embodiments, the automated training service can generate the training instructions by dynamically adapting to the current working environment. The working environment can include one or more attributes related to the working environment. These attributes can include but are not limited to assigned duties in the environment, required skills, and the like. For example, if a previous patrol officer reported an incident where a broken window was found on a post, the automated training service may generate instructions related to the required patrol protocol in the incident that found a broken window to the next patrol officer assigned to the post.

In some embodiments, the automated training service may dynamically generate the training instructions by analyzing the workflow related environments in real time or near real time. For example, the automated training service (e.g., implemented by a security patrol service provider) can receive data from one or more sensors deployed in the physical environment. Illustratively, sensors, such as motion sensors, temperature sensors, smoke detectors, humidity sensors, light sensors, noise sensors, occupancy sensors, pressure sensors, etc., can be deployed within a security patrol area. The automated training service may identify one or more events that indicate abnormalities of the one or more data received from these sensors. For example, the noise level detected by the noise sensor is higher than the normal range. In these examples, the automated training service can generate training instructions prior to the patrol officer initiating patrolling the posts. In this example, the patrol officer can be trained by resoling one or more questions generated as the training instructions, thus, the patrol officer can be trained on what the officer needs to do in order to resolve any issue related to the detected abnormalities in the patrol posts. In some cases, a machine learning or artificial intelligence (ML/AI) component can be utilized to generate the training instructions or scenarios automatically. In addition, the ML/AI component can generate additional scenarios upon determining that the employee needs to perform instructions regarding the additional scenarios before performing duty. For example, if the employee's answer regarding the initial scenarios did not meet the threshold score, the ML/AI component may generate additional training scenarios.

In some embodiments, the automated training service can include various criteria in providing the training instructions. The criteria can be based on the priority of each instruction provided to the employee. For example, if patrol related instructions include 10 questions to be answered by the employee, each question can have a different weight based on the priority. For example, if a broken window is previously reported in a post area, a question related to the patrol protocol of post-action after discovering the broken window may have a higher weight. In some cases, the patrol officer may not be able to initiate their patrol service until the officer fully training the instructions with the weight above a threshold. In some cases, the automated training service can score each employee's performance on taking the training scenarios and store the score in the database as profile information for the employee.

In accordance with one or more aspects of the present disclosure, the automated training service can implement a machine learned model to generate the training instructions by analyzing various data related to the workflow, individual employee's profile, and/or the dynamically changing working environment. For example, the machine learned model may analyze the current working environment and generate additional training instructions and/or modify existing training instructions. In some embodiments, the machine learned model can be utilized to analyze individual employee's performance of the duty and update the training instructions. For example, as a patrol officer receives the training instructions, the next training instructions can be automatically updated based on the employee's level of skill. In addition, the automated training service can provide training instruction in various aspects. For example, the automated training service can generate a training question in various aspects, thus, the employee may need to provide answers in various training instructions that based on the same scenario.

Although aspects of the present disclosure will be described with regard to illustrative network components, interactions, and routines, one skilled in the relevant art will appreciate that one or more aspects of the present disclosure may be implemented in accordance with various environments, system architectures, customer computing device architectures, and the like. Similarly, references to specific devices, such as a customer computing device, can be considered to be general references and not intended to provide additional meaning or configurations for individual customer computing devices. Additionally, the examples are intended to be illustrative in nature and should not be construed as limiting.

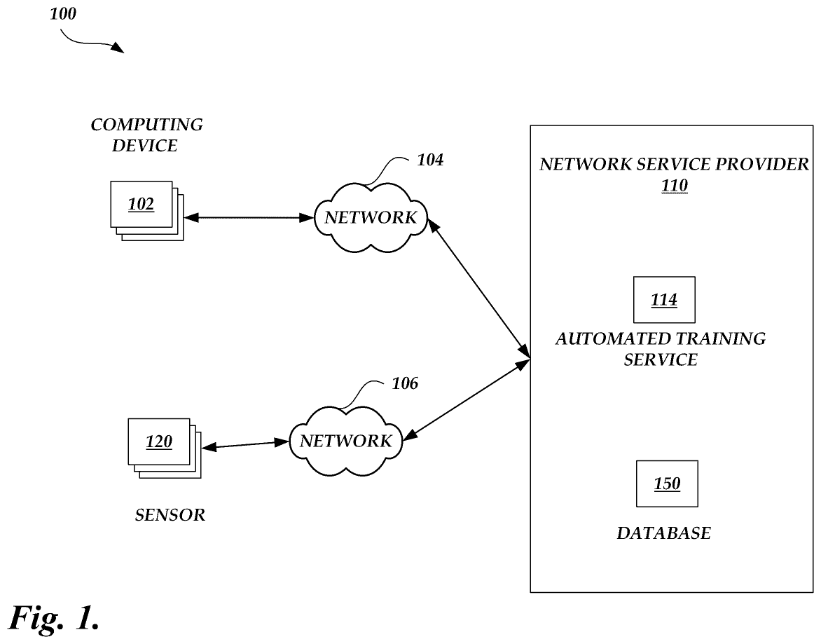

FIG. 1 depicts a block diagram of an embodiment of the system 100. The system 100 can include a network 104, the network connecting a plurality of computing devices 102, and the network service provider 110. The system 100 can also include a network 106, the network connecting a number of sensors 120, and network service provider 110. Illustratively, the various aspects associated with the network service provider 110 can be implemented as one or more components that are associated with one or more functions or services. The components may correspond to software modules implemented or executed by one or more customer computing devices, which may be separate stand-alone customer computing devices. Accordingly, the components of the network service provider 110 should be considered as a logical representation of the service, not requiring any specific implementation on one or more customer computing devices.

Networks 104, 106 as depicted in FIG. 1, can connect the network service provider 110 and the computing devices 102 and the sensors 120, respectively. The networks 104, 106 can comprise any combination of wired and/or wireless networks, such as one or more direct communication channels, local area networks, wide area network, personal area network, and/or the Internet, for example. In some embodiments, the communication between the network service provider 110 and the computing devices 102 and/or the sensors 120 may be performed via a short-range communication protocol, such as Bluetooth, Bluetooth low energy (“BLE”), and/or near field communications (“NFC”).

In some embodiments, the networks 104, 106 may be a private or semi-private network, such as a corporate or university intranet. The networks 104, 106 may include one or more wireless networks, such as a Global System for Mobile Communications (GSM) network, a Code Division Multiple Access (CDMA) network, a Long Term Evolution (LTE) network, or any other type of wireless network. The networks 104, 106 can use protocols and components for communicating via the Internet or any of the other aforementioned types of networks. For example, the protocols used by the networks 104, 106 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

The types of network 104 and network 106 can be the same type of network or different types of network. These types can be determined based on specific applications, and the present disclosure does not limit these types of networks.

As described in FIG. 1, the network service provider 110 can be communicatively coupled with the computing devices 102 via the network 104. The network service provider 110 can connect any number of computing devices 102. Each computing device 102 can be utilized by an employee and configured to provide work related information. For example, if the network service provider 110 is adapted for the security patrol service provider, the employee can be the patrol officer. In some embodiments, the computing devices 102 can be any computing device such as a desktop, laptop or tablet computer, personal computer, tablet computer, wearable computer, personal digital assistant (PDA), hybrid PDA/mobile phone, mobile phone, smartphone, voice command device, digital media player, and the like. In some embodiments, the computing devices 102 may execute an application (e.g., a browser, a stand-alone application, etc.) that allows a user (e.g., an employee) to access interactive user interfaces, view images, analyses, or aggregated data, and/or the like as described herein. In various embodiments, users (e.g., employees) may interact with the network service provider via various devices. Such interactions may typically be accomplished via interactive graphical user interfaces or voice commands, however, alternatively, such interactions may be accomplished via command line and/or other means.

In certain instances, the computing device 102 can offer a graphical interface equipped with features designed to display training instructions received from the network service provider 110. For example, the patrol officer can utilize the graphical interface to receive the training instructions and perform the training by reporting any feedback in response to the training instructions. The present disclosure does not limit the functionality types of graphical interfaces, and the types can be determined based on specific applications.

As described in FIG. 1, the network service provider 110 can be communicatively coupled with the sensors 120 via the network 106. The network service provider 110 can connect any number of sensors 120. The present disclosure does not limit the types of sensors, and the types can be determined based on specific applications. For example, the types of sensors utilized for security patrol can include but are not limited to temperature sensors, proximity sensors, light sensors, motion sensors, gas sensors, image sensors, radar sensors, etc.

In some embodiments, any suitable type and number of sensors 120 can be deployed in working areas. For example, each security post can include one or more types of sensors 102, where the types and number of sensors can be determined based on the characteristics of the security post.

The network service provider 110, as shown in FIG. 1, can include an automated training service 114 and database 150. The automated training service 114 can be configured to generate training instructions based on individual employee profiles and workflow and dynamically changing working environment. The workflow can generally refer to an employee's duty. For instance, the workflow of a patrol officer may encompass their shift timing and the specific responsibilities tied to their patrol duties.

In some embodiments, the automated training service 114 can provide training instructions to the employees. The training instructions can be work related training instructions, and the employees, prior to executing their job duties, can receive the training instructions from the automated training service 114. In various examples, the automated training service 114 can generate the training instructions by processing data received from the employee's computing device. For example, when an employee check in (or clock in) to initiate executing the employee's duty, the automated training service 114 can be triggered to generate the training instructions. In some embodiments, the training instructions can be dynamically generated based on the workflow for each employee.

In various examples, the automated training service 114 can modify or generate additional training environments by processing individual employee's profiles. The profile can include attributes related to the employee, such as rank (and associated duty), skills, performance history when executing the duty, previous evaluation data, training history of the employees, and the like. For example, the training instructions are modified based on the rank of the employee and/or the skills of the employee. Furthermore, the training instructions can be modified based on historical performance or evaluation records of the employee. For instance, if the employee, a security patrol officer, did not satisfy performance criteria for a specific duty, the training instructions can be tailored to this scenario. In another example, if the patrol officer has a special skill, such as a specification of using a type of gun, the training instruction can be related to this special skill. In some embodiments, the automated training service can generate the training instructions by dynamically adapting to the current working environment. The working environment can include one or more attributes related to the working environment. These attributes can include but are not limited to assigned duties in the environment, required skills, and the like. For example, if a previous patrol officer reported an incident where a broken window is found at a post, the automated training service may generate instructions related to the required patrol protocol in the incident that found a broken window.

In certain examples, the automated training service 114 can filter the generated training instructions by using various criteria. For example, each generated training instruction can include weight based on the priority of each instruction, and the automated training service 114 can filter these instructions based on the weight value. In some examples, the criteria can be based on one or more attributes of the employee. For instance, the criteria can be associated with the employee's previous performance, such that if the employee made a mistake previously, the criteria can be related to the previous mistake, and thus, the employee can be trained to prevent by repeating the same mistake. This criterion can be determined based on the attributes of the employee, and the present disclosure does not limit the criteria to any specific type.

The network service provider 110 can also include a database 150. The database 150 can store information related to the profile of each employee, workflow, historical attributes of each employee and the working environment, and the like. The database 150 can include any data structure (and/or combinations of multiple data structures) for storing and/or organizing data, including, but not limited to, relational databases (e.g., Oracle databases, PostgreSQL databases, etc.), non-relational databases (e.g., NoSQL databases, etc.), in-memory databases, spreadsheets, comma separated values (CSV) files, extensible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) is to be understood as being stored in one or more data stores. Additionally, although the present disclosure may show or describe data as being stored in combined or separate databases, in various embodiments, such data may be combined and/or separated in any appropriate way into one or more databases, one or more tables of one or more databases, etc.

The embodiment of the system 100 is merely provided as example purposes, and the present disclosure does not limited to this embodiment. Furthermore, one or more component of the system 100 can be removed or added based on specific applications. For example, the sensors 120 can be deleted in some embodiments.

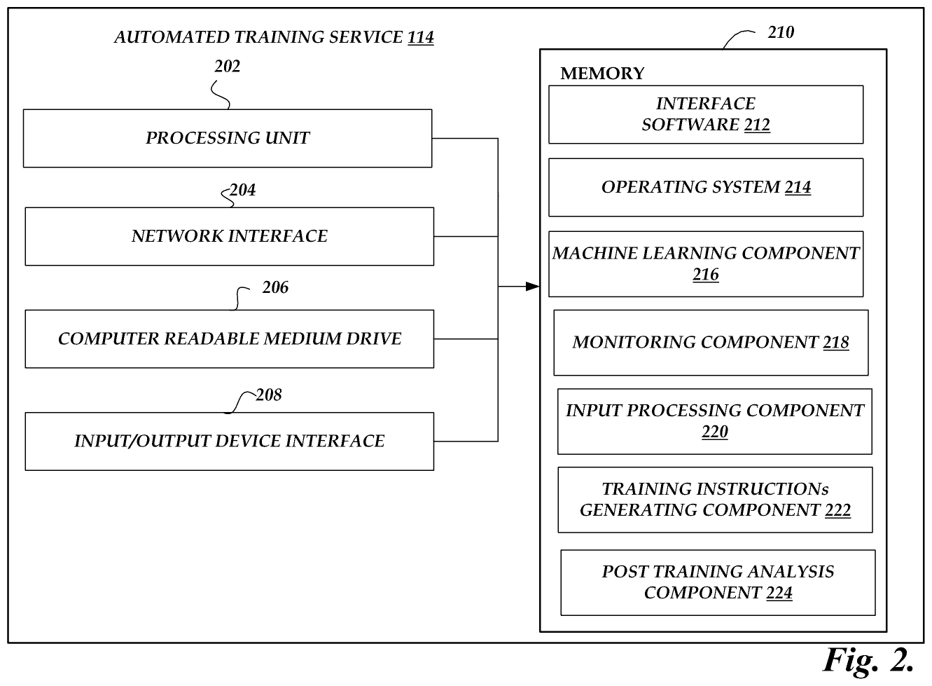

FIG. 2 depicts one embodiment of the architecture of an illustrative automated training service 114. The automated training service 114 can be configured to generate training instructions. More specifically, the automated training service 114 can provide instructions to employees in prior to initiating the duty in a dynamically changing environment. The general architecture of the automated training service 114 depicted in FIG. 2 includes an arrangement of computer hardware and software components that may be used to implement aspects of the present disclosure. As illustrated, the automated training service 114 includes a processing unit 202, a network interface 204, a computer-readable medium drive 206, and an input/output device interface 208, all of which may communicate with one another by way of a communication bus. The components of the automated training service 114 may be physical hardware components or implemented in a virtualized environment.

The network interface 204 may provide connectivity to one or more networks, such as the networks 104 and 106 of FIG. 1. The processing unit 202 may thus receive information and instructions from other computing systems or services via a network. The processing unit 202 may also communicate to and from memory 210 and further provide output information for an optional display via the input/output device interface 208. In some embodiments, the automated training service 114 may include more (or fewer) components than those shown in FIG. 2.

The memory 210 may include computer program instructions that the processing unit 202 executes in order to implement one or more embodiments. The memory 210 generally includes RAM, ROM, or other persistent or non-transitory memory. The memory 210 may store an operating system 214 that provides computer program instructions for use by the processing unit 202 in the general administration and operation of the automated training service 114. The memory 210 may further include computer program instructions and other information for implementing aspects of the present disclosure. For example, in one embodiment, the memory 210 includes interface software 212 for communicating with other components or services and performing one or more aspects as disclosed herein.

The memory 210 may include a machine learning component 216. The machine learning component 216 can be configured to analyze data and generate dynamic instructions in accordance with one or more embodiments as disclosed herein. In some embodiments, a number of different types of algorithms may be used by the machine learning component 216 to generate the models. For example, certain embodiments herein may use a logistical regression model, decision trees, random forests, convolutional neural networks, deep networks, or others. However, other models are possible, such as a linear regression model, a discrete choice model, or a generalized linear model. The machine learning algorithms can be configured to adaptively develop and update the models over time based on new input received by the machine learning component 216. For example, the models can be regenerated on a periodic basis as new human physical characteristics or bio information is available to help keep the predictions in the model more accurate as the information evolves over time. In some cases, the machine learning component 216 can be utilized to generate the training instructions or scenarios automatically. In addition, the machine learning component 216 can generate additional scenarios upon determining that the employee needs to perform instructions regarding the additional scenarios before performing duty. For example, if the employee's answer regarding the initial scenarios did not meet the threshold score, the machine learning component 216 may generate additional training scenarios.

Some non-limiting examples of machine learning algorithms that can be used to generate and update the parameter functions or prediction models can include supervised and non-supervised machine learning algorithms, including regression algorithms (such as, for example, Ordinary Least Squares Regression), instance-based algorithms (such as, for example, Learning Vector Quantization), decision tree algorithms (such as, for example, classification and regression trees), Bayesian algorithms (such as, for example, Naive Bayes), clustering algorithms (such as, for example, k-means clustering), association rule learning algorithms (such as, for example, Apriori algorithms), artificial neural network algorithms (such as, for example, Perceptron), deep learning algorithms (such as, for example, Deep Boltzmann Machine), dimensionality reduction algorithms (such as, for example, Principal Component Analysis), ensemble algorithms (such as, for example, Stacked Generalization), and/or other machine learning algorithms. These machine learning algorithms may include any type of machine learning algorithm, including hierarchical clustering algorithms and cluster analysis algorithms, such as a k-means algorithm. In some cases, the performing of the machine learning algorithms may include the use of an artificial neural network. By using machine-learning techniques, large amounts (such as terabytes or petabytes) of player interaction data may be analyzed to generate models.

The memory 210 may include a machine learning component 216. The machine learning component 216 can be configured to analyze data and generate dynamic training instructions in accordance with one or more embodiments, as disclosed herein. In some embodiments, a number of different types of algorithms may be used by the machine learning component 216 to generate the models. For example, certain embodiments herein may use a logistical regression model, decision trees, random forests, convolutional neural networks, deep networks, or others. However, other models are possible, such as a linear regression model, a discrete choice model, or a generalized linear model. The machine learning algorithms can be configured to adaptively develop and update the models over time based on new input received by the machine learning component 216. For example, the models can be regenerated on a periodic basis as new human physical characteristics or bio information is available to help keep the predictions in the model more accurate as the information evolves over time.

Some non-limiting examples of machine learning algorithms that can be used to generate and update the parameter functions or prediction models can include supervised and non-supervised machine learning algorithms, including regression algorithms (such as, for example, Ordinary Least Squares Regression), instance-based algorithms (such as, for example, Learning Vector Quantization), decision tree algorithms (such as, for example, classification and regression trees), Bayesian algorithms (such as, for example, Naive Bayes), clustering algorithms (such as, for example, k-means clustering), association rule learning algorithms (such as, for example, Apriori algorithms), artificial neural network algorithms (such as, for example, Perceptron), deep learning algorithms (such as, for example, Deep Boltzmann Machine), dimensionality reduction algorithms (such as, for example, Principal Component Analysis), ensemble algorithms (such as, for example, Stacked Generalization), and/or other machine learning algorithms. These machine learning algorithms may include any type of machine learning algorithm, including hierarchical clustering algorithms and cluster analysis algorithms, such as a k-means algorithm. In some cases, the performing of the machine learning algorithms may include the use of an artificial neural network. By using machine-learning techniques, large amounts (such as terabytes or petabytes) of player interaction data may be analyzed to generate models.

The memory 210 may include a monitoring component 218. The monitoring component 218 can be configured to monitor the employees to determine whether the employees are prepared to initiate their work duty. In some examples, within a threshold time period before initiating the work, the training instruction can be provided to the employees. For example, this training instruction can be provided to the patrol officer when the officer indicates the readiness of initiating working and/or enters a post.

In some cases, the computing devices 102 utilized by employees can provide an input that the employees are prepared to initiate working. For example, the computing device 102 may equipped with a functionality that the employee can indicate their readiness to initiate working, such as via selection of check in (or clock in time). These indications can be provided in the computing devices 102 with various graphical representation, and the present disclosure does not limit these types of representations.

In some embodiments, the computing devices 102 can be equipped with a location tracking system, such as GPS module, and the monitoring component 218 can periodically or continuously receive the location information of the computing devices 102. In these embodiments, the monitoring component 218 can detect that the physical location of the computing device 102 is within proximity to the working area. In addition, the monitoring component 218 can determine whether the employee is prepared to initiate working based on the location of the computing device associated with the employee and the workflow information (e.g., assigned duty) of the employee. For example, if the employee's workflow indicates that the employee is scheduled to initiate work at 8:00 am at location A, the monitoring component 218 automatically determines that the employee is prepared work when the location of the employee's computing device is indicating in proximity to the location A at or after 8:00 AM.

In various embodiments, the monitoring component 218 can also authenticate the employee's computing device 102. In some cases, the monitoring component 218 can provide an authentication token, such as an application program interface (API) token to each computing device 102. For example, each computing device 102 may include a unique identifier associated with its token, and the monitoring component 218 can verify these API token identifiers to authenticate the computing device 102. Once, the monitoring component 218 authenticate the computing device 102 by verifying the token, the computing device 102 and the monitoring component 218 can be communicatively coupled.

The memory 210 can further include an input processing component 220. The input processing component 220 can be configured to analyze input data received from the computing devices 102 and the sensors 120.

In some embodiments, the input processing component 220 processes the required work requirements for each employee to determine workflows (or duty) associated each employee. In some cases, the workflows can be identified based on a master plan. For example, the master plan of a security patrol service provider can be provided as the hierarchical data. The hierarchical data can include various levels, such that the highest level of the data structure can be a building, the lower layer can be floors, the lower layer can be rooms within the floors, and the lowest layer can be the posts in each room. The master plan may include assigned one or more required workflow for each level of the hierarchical data structure. For example, at the highest level, the master plan may include assigned attributes of the types of patrol areas, required security level, patrol time, etc. In the lowest level of the hierarchical data, such as posts, each post can be associated with the required patrol attributes for each post, such as the number of patrol officials, patrol time, the required capability of the patrol official, and the like. In these embodiments, the workflows can be generated based on the required duty assigned to each post. In some examples, the workflows can be provided in accordance with the shift schedule of patrol officers.

In some embodiments, the input processing component 220 can receive inputs from computing devices 102. In some examples, the input processing component 220 can receive profile information of the employee associated with the computing device 102. In some examples, the profile information corresponds to the employee's attributes, such as rank (and associated duty), skills, performance history when executing the duty, previous evaluation data, training history of the employees, and the like.

In some embodiments, the input processing component 220 can receive additional inputs from working environment information stored in the database 150. The working environment can include one or more attributes related to the working environment. These attributes can include but are not limited to assigned duties in the environment, required skills, and the like. In some examples, these attributes can be updated by processing data received from various sensors deployed in the workplace. For example, a patrol service provider can receive sensor data from the sensors deployed in the target patrol areas, and the machine learned models utilized by the patrol service provider can generate the training data based on the processing results of the sensor data.

The memory 210 can also include training instructions generating component 222. In some embodiments, the training instructions generating component 222 can generate the training instructions based on the workflows of each employee. In various examples, the training instructions generating component 222 can generate a plurality of training instructions associated with the workflow. In these examples, the training instructions generating component 222 can utilize the machine learning component 216 to generate the plurality of training instructions. For example, the machine learning component 216 by utilizing its machine learned models can generate the training instructions in a plurality of scenarios. For instance, the machine learning component 216 utilized by a security patrol service provider can determine the plurality of scenarios associated with the workflow and generate the training instructions based on these scenarios. The generated plurality of training instructions can be stored in the database 150 of the network service provider 110.

In some embodiments, the training instructions generating component 222 can prioritize the generated instructions based on priority. For example, each training instruction can have its weight that represents the level of the priority. In these embodiments, the training instructions generating component 222 can provide the one or more training instructions to the employee via the computing device by filtering the generated training instructions based on the priority criteria. Further, in these embodiments, the weight of each training instruction can be dynamically changed based on the current working environment and/or employee's profile. In some cases, the training instructions generating component 222 provides the training scenarios with acceptable answers (or a range of acceptable answers). In some examples, these training scenarios can be provided in a certain sequence or randomly. In some cases, these training scenarios can be provided once or recurrently.

In various embodiments, the training instructions generating component 222 can further process the generated training instructions based on employee's profile information. In some examples, the profile information corresponds to the employee's attributes, such as rank (and associated duty), skills, performance history when executing the duty, previous evaluation data, training history of the employees, and the like. This profile information is stored in the database 150 and constantly updated. For example, the employee's evaluation data can be constantly updated as the new evaluation data are generated. Furthermore, the employee's rank can be updated as the employee is promoted.

In some cases, the training instructions can be updated based on these employee's profile information. For example, in accordance with the employee's level of experience or skills, the training instructions can be provided with variance to each employee. In addition, each weight of the training instruction can be varied based on the employee's profile information. Thus, the training instructions generating component 222 can provide customized (or updated) training instructions to each employee by dynamically adapting its instructions based on each employee's profile.

In various examples, the training instructions generating component 222 can further update the training instructions based on the working environment information. For example, if a previous security patrol officer discovered a broken window at a post area, the instructions on the post area can be updated to train the following patrol officer in a scenario of discovering broken windows. In this example, the priority related to the scenario that discovering the broken windows can have a higher weight (e.g., higher priority). Thus, the training instructions generating component 222 can dynamically update its training instructions based on the current working environments.

In some examples, the training instructions generating component 222 can provide the training instructions to the employee by further filtering the generated training instructions based on the workflows. For example, the training instructions generating component 222 can filter the training instructions by utilizing one or more criteria defined based on one or more attributes of the employee's profile. For example, the training instructions generating component 222 can filter the training instructions based on employee's level of experience and/or skills. In addition, the training instructions generating component 222 can also filter the training instructions based on one or more attributes defined from the working environment. For example, if a previous employee reported an incident, then the training instructions generating component 222 can filter the training instructions to identify instructions related to the reported incident.

In addition, the training instructions generating component 222 can modify or update the generated training instructions when one or more workflows are changed. For example, if the workflows are related to the security patrol service and that the workflows are changed due to the updated security patrol service contract (e.g., updated security patrol requirements), the training instructions generating component 222 can automatically update the existing training instructions.

In some embodiments, to ensure the training of the employee, the training instructions generating component 222 can provide a same type of training instructions in various scenarios. Thus, the knowledge of the employee can be ensured by answering the same type of training instructions in these scenarios.

The memory 210 can further include a post training analysis component 224. In various examples, the training instructions generated at the training instructions generating component 222 can be provided as the questionnaire. For example, when the employee is prepared to initiate work, as determined by monitoring component 218, the training instructions generating component 222 can automatically generate the questions (as the training instructions) and provide these questions to the employee by displaying the questions on the display of the computing device. The present disclosure does not limit the number of questions.

In some embodiments, the post training analysis component 224 can receive the answers to these questions and verify whether the employee can initiate the work. In some examples, the post training analysis component 224 can verify based on threshold number of correct answers. In some embodiments, the post training analysis component 224 can only verify if the answer(s) are correct. For example, the employee might be required to correctly answer those questions associated with high priority training instructions (weight of the instructions). In some examples, the post training analysis component 224 can provide further additional instructions if the employee was not verified. In some cases, the post training analysis component 224 can score each employee's performance on taking the training scenarios and store the score in the database as profile information for the employee.

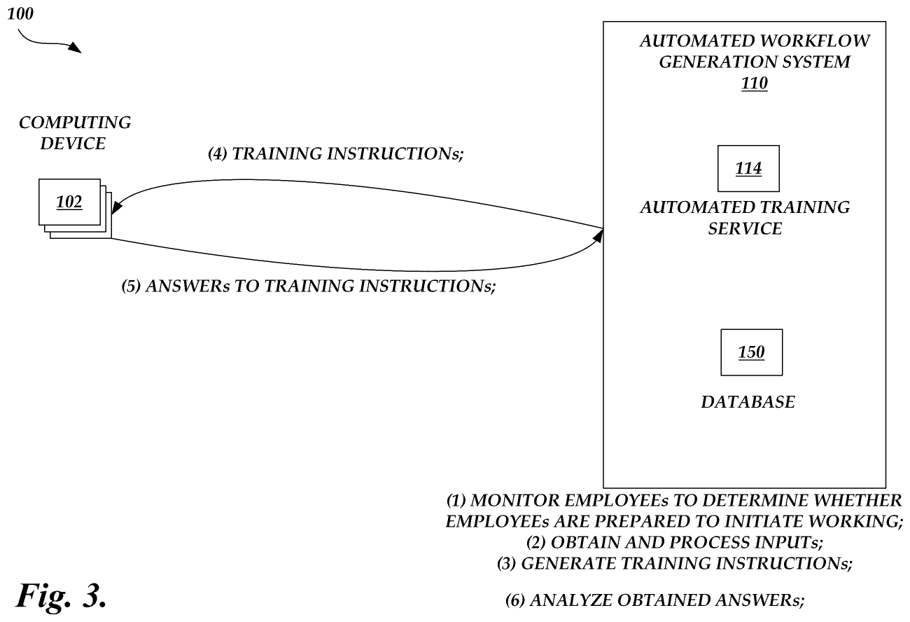

Turning now to FIG. 3, illustrative interactions of the components of the system 100, as shown in FIG. 1, will be described. For purposes of the illustration, it can be assumed that the network service provider 110 has been configured in a manner that implements the automated training service 114. For the purpose of description, FIG. 3 can be described with respect to a security patrol service provider. The present application is not intended to be limited to any particular type of service or the number of individual services that may be accessed or generate processing results as part of the execution of an application.

With reference to FIG. 3, an illustrative interaction of generating processing results that can be utilized in the aspects of automated training service and/or generating instructions will be described. The interaction is illustrative.

At (1), the automated training service 114 monitors employees to determine whether the employees are prepared to initiate work. The automated training service 114 can be configured to monitor the employees to determine whether they are prepared to initiate their work duties. In some examples, within a threshold time period before initiating the work, the training instruction can be provided to the employees. For example, this training instruction can be provided to the patrol officer when the officer indicates the readiness to initiate working and/or enters a post.

In some cases, the computing devices 102 utilized by employees can provide an input that the employees are prepared to initiate working. For example, the computing device 102 may equipped with a functionality that the employee can indicate their readiness to initiate working, such as via selection of check in (or clock in time). Such indications can be provided in the computing devices 102 with various graphical representation, and the present disclosure does not limit these types of the representations.

In some embodiments, the computing devices 102 can be equipped with a location tracking system, such as GPS module, and the automated training service 114 can periodically or continuously receive the location information of the computing devices 102. In these embodiments, the automated training service 114 can detect that the physical location of the computing device 102 is within proximity to the working area. In addition, the automated training service 114 can determine whether the employee is prepared to initiate working based on the location of the computing device associated with the employee and the workflow information (e.g., assigned duty) of the employee. For example, if the employee's workflow indicates that the employee is scheduled to initiate work at 8:00 am at location A, the automated training service 114 automatically determines that the employee is prepared work when the location of the employee's computing device is indicating in proximity to the location A at or after 8:00 am.

In various embodiments, the automated training service 114 can also authenticate the employee's computing device 102. In some cases, the automated training service 114 can provide an authentication token, such as an application program interface (API) token to each computing device 102. For example, each computing device 102 may include a unique identifier associated with its token, and the automated training service 114 can verify these API token identifiers to authenticate the computing device 102. Once, the automated training service 114 authenticates the computing device 102 by verifying the token, the computing device 102 and the automated training service 114 can be communicatively coupled.

At (2), the automated training service 114 obtains inputs (e.g., or a set of inputs) from one or more computing devices 102 and processes the obtained inputs. The inputs (e.g., the set of inputs) can include geometry identifiers and time identifiers associated with each of the one or more computing devices. In some examples, the automated training service 114 can receive inputs related to the workflows. For example, the master plan of a security patrol service provider can be provided as hierarchical data. The hierarchical data can include various levels, such that the highest level of the data structure can be a building, the lower layer can be floors, the lower layer can be rooms within the floors, and the lowest layer can be the posts in each room. The master plan may include assigned one or more required workflows for each level of the hierarchical data structure. For example, at the highest level, the master plan may include assigned attributes of the types of patrol areas, required security level, patrol time, etc. In the last level of the hierarchical data, such as posts, each post can be associated with the required patrol attributes for each post, such as the number of patrol officials, patrol time, the required capability of the patrol official, and the like. In these embodiments, the instruction can be generated based on the workflow assigned to each post. In some examples, the instruction is provided in accordance with the shift schedule of patrol officers. For example, within a threshold time period before initiating the patrol, the instruction can be provided to the patrol officers. In some examples, this instruction can be provided to the patrol officer when the officer enters a post.

In some examples, the inputs can be obtained from various sensors. For example, various types of sensors can be deployed in workspace, such that, in non-limiting examples, temperature sensors, proximity sensors, light sensors, motion sensors, gas sensors, image sensors, radar sensors, etc., can be deployed for security patrol service provider.

In some embodiments, the automated training service 114 can receive inputs from computing devices 102. In some examples, the automated training service 114 can receive profile information of the employee associated with the computing device 102. In some examples, the profile information corresponds to the employee's attributes, such as rank (and associated duty), skills, performance history when executing the duty, previous evaluation data, training history of the employees, and the like.

In some embodiments, the automated training service 114 can receive additional inputs from working environment information stored in the database 150. The working environment can include one or more attributes related to the working environment. These attributes can include but are not limited to assigned duties in the environment, required skills, and the like. In some examples, these attributes can be updated by processing data received various sensors deployed in the workplace. For example, a patrol service provider can receive sensor data from the sensors deployed in the target patrol areas, and the machine learned models utilized by the patrol service provider can generate the training data based on the processing results of the sensor data.

In some embodiments, the automated training service 114 obtains a set of additional inputs from a database 150. In some examples, the set of additional inputs includes a set of target areas, and each of the target areas can include one or more sub-areas.

At (3), the automated training service 114 generates training instructions. In various examples, the training instructions can be provided as questionnaire. For example, when the employee is prepared to initiate work, the automated training service 114 can automatically generate the questions (as the training instructions in accordance with one or more embodiments disclosed herein) and provide these questions to the employee by displaying the questions on the display of the computing device. The present disclosure does not limit the number of questions.

In some embodiments, the automated training service 114 can generate training instructions based on the workflows of each employee. In various examples, the automated training service 114 can generate a plurality of training instructions associated with the workflow. In these examples, the automated training service 114 can utilize the machine learning component 216 to generate the plurality of training instructions. For example, the machine learning component 216, by utilizing its machine learned models, can generate the training instructions in a plurality of scenarios. For instance, the machine learning component 216 utilized by a security patrol service provider can determine the plurality of scenarios associated with the workflow and generate the training instructions based on these scenarios. The generated plurality of training instructions can be stored in the database 150 of the network service provider 110.

In some embodiments, the automated training service 114 can prioritize the generated instructions based on priority. For example, each training instruction can have its weight that represents the level of the priority. In these embodiments, the automated training service 114 can provide the one or more training instructions to the employee via the computing device by filtering the generated training instructions based on the priority criteria. Further, in these embodiments, the weight of each training instruction can be dynamically changed based on the current working environment and/or employee's profile.

In various embodiments, the automated training service 114 can further process the generated training instructions based on employee's profile information. In some examples, the profile information corresponds to the employee's attributes, such as rank (and associated duty), skills, performance history when executing the duty, previous evaluation data, training history of the employees, and the like. This profile information is stored in the database 150 and constantly updated. For example, the employee's evaluation data can be constantly updated as the new evaluation data are generated. Furthermore, the employee's rank can be updated as the employee is promoted.

In some cases, the training instructions can be updated based on these employee's profile information. For example, in accordance with the employee's level of experience or skills, the training instructions can be provided with variance to each employee. In addition, each weight of the training instruction can be varied based on the employee's profile information. Thus, the automated training service 114 can provide customized (or updated) training instructions to each employee by dynamically adapting its instructions based on each employee's profile.

In various examples, the automated training service 114 can further update the training instructions based on the working environment information. For example, if a previous security patrol officer discovered broken window at a post area, the instructions on the post area can be updated to train the following patrol officer in a scenario of discovering broken windows. In this example, the priority related to the scenario that discovering the broken windows can have a higher weight (e.g., higher priority). Thus, the automated training service 114 can dynamically update its training instructions based on the current working environments.

In some examples, the automated training service 114 can provide training instructions to the employee by further filtering the generated training instructions based on the workflows. For example, the automated training service 114 can filter the training instructions by utilizing one or more criteria defined based on one or more attributes of the employee's profile. For example, the automated training service 114 can filter the training instructions based on the employee's level of experience and/or skills. In addition, the automated training service 114 can also filter the training instructions based on one or more attributes defined from the working environment. For example, if a previous employee reported an incident, then the automated training service 114 can filter the training instructions to identify instructions related to the reported incident.

In addition, the automated training service 114 can modify or update the generated training instructions when one or more workflows are changed. For example, if the workflows are related to the security patrol service and that the workflows are changed due to the updated security patrol service contract (e.g., updated security patrol requirements), the automated training service 114 can automatically update the existing training instructions.

In some embodiments, to ensure the training of the employee, the automated training service 114 can provide the same type of training instructions in various scenarios. Thus, the knowledge of the employee can be ensured by answering the same type of training instructions in these scenarios. In some cases, the automated training service 114 can utilize ML/AI component to generate the training instructions or scenarios automatically. In addition, the automated training service 114 can generate additional scenarios upon determining that the employee needs to perform instructions regarding the additional scenarios before performing duty. For example, if the employee's answer regarding the initial scenarios did not meet the threshold score, the automated training service 114 may generate additional training scenarios.

At (4), the automated training service 114 transmits the generated training instructions to the computing device 102. In some examples, these instructions can be displayed on the computing device. At (5), the automated training service 114 receives the answers to these questions, where the answers are provided by the employee associated with the computing device 102.

At (6), the automated training service 114 analyzes the obtained answers to verify whether the employee can initiate the work. In some examples, the automated training service 114 can verify based on the threshold number of correct answers. In some embodiments, the automated training service 114 can only verify if the answer(s) are correct. For example, the employee might be required to correctly answer those questions associated with high priority training instructions (weight of the instructions). In some examples, the automated training service 114 can provide further additional instructions if the employee was not verified. In some cases, the automated training service 114 can score each employee's performance on taking the training scenarios and store the score in the database as profile information for the employee.

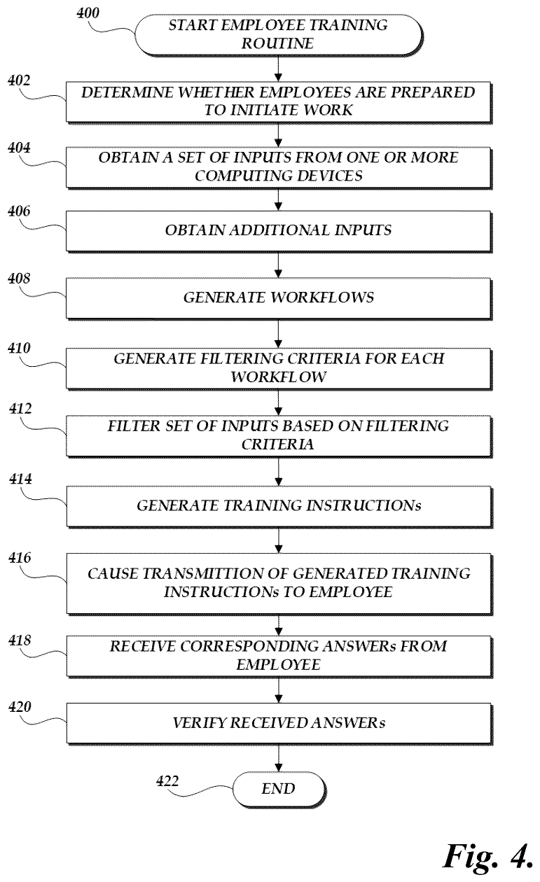

Turning now to FIG. 4, An employee training routine 400 based on various aspects, as disclosed in the present disclosure, will be described. For the purpose of illustration, the network service provider 110 described in FIG. 4 is implemented by a security patrol service provider.

At block 402, the automated training service 114 determines whether the employees are prepared to initiate work. The automated training service 114 can be configured to monitor the employees to determine whether they are prepared to initiate their work duties. In some examples, within a threshold time period before initiating the work, the training instruction can be provided to the employees. For example, this training instruction can be provided to the patrol officer when the officer indicates the readiness to initiate working and/or enter a post.

In some cases, the computing devices 102 utilized by employees can provide an input that the employees are prepared to initiate working. For example, the computing device 102 may equipped with a functionality that the employee can indicate their readiness to initiate working, such as via selection of check in (or clock in time). These indication can be provided in the computing devices 102 with various graphical representations, and the present disclosure does not limit these types of representations.

In some embodiments, the computing devices 102 can be equipped with a location tracking system, such as GPS module, and the automated training service 114 can periodically or continuously receive the location information of the computing devices 102. In these embodiments, the automated training service 114 can detect that the physical location of the computing device 102 is within proximity to the working area. In addition, the automated training service 114 can determine whether the employee is prepared to initiate working based on the location of the computing device associated with the employee and the workflow information (e.g., assigned duty) of the employee. For example, if the employee's workflow indicates that the employee is scheduled to initiate work at 8:00 am at location A, the automated training service 114 automatically determines that the employee is prepared for work when the location of the employee's computing device is indicating in proximity to the location A at or after 8:00 am.

In various embodiments, the automated training service 114 can also authenticate the employee's computing device 102. In some cases, the automated training service 114 can provide an authentication token, such as an application program interface (API) token to each computing device 102. For example, each computing device 102 may include a unique identifier associated with its token, and the automated training service 114 can verify these API token identifiers to authenticate the computing device 102. Once, the automated training service 114 authenticates the computing device 102 by verifying the token, the computing device 102 and the automated training service 114 can be communicatively coupled.

At block 404, the automated training service 114 obtains a set of inputs. In some embodiments, the automated training service 114 obtains the set of inputs from one or more computing devices 102. In some examples, the set of inputs includes geometry identifiers and time identifiers of each of the plurality of computing devices. In some examples, the automated training service 114 can receive inputs related to the workflows. For example, the master plan of a security patrol service provider can be provided as hierarchical data. The hierarchical data can include various levels, such that the highest level of the data structure can be a building, the lower layer can be floors, the lower layer can be rooms within the floors, and the lowest layer can be the posts in each room. The master plan may include assigned one or more required workflow for each level of the hierarchical data structure. For example, at the highest level, the master plan may include assigned attributes of the types of patrol areas, required security level, patrol time, etc. In the lost level of the hierarchical data, such as posts, each post can be associated with the required patrol attributes for each post, such as the number of patrol officials, patrol time, the required capability of the patrol official, and the like. In these embodiments, the instruction can be generated based on the workflow assigned to each post. In some examples, the instruction is provided in accordance with shift schedule of patrol officers. For example, within a threshold time period before initiating the patrol, the instruction can be provided to the patrol officers. In some examples, this instruction can be provided to the patrol officer when the officer enters a post.

In some examples, the inputs can be obtained from various sensors. For example, various types of sensors can be deployed at workspace, such that, in non-limiting examples, temperature sensors, proximity sensors, light sensors, motion sensors, gas sensors, image sensors, radar sensors, etc., can be deployed for security patrol service provider.

In some embodiments, the automated training service 114 can receive inputs from computing devices 102. In some examples, the automated training service 114 can receive profile information of the employee associated with the computing device 102. In some examples, the profile information corresponds to the employee's attributes, such as rank (and associated duty), skills, performance history when executing the duty, previous evaluation data, training history of the employees, and the like.

At block 406, the automated training service 114 can receive additional inputs from working environment information stored in the database 150. The working environment can include one or more attributes related to the working environment. These attributes can include but are not limited to assigned duties in the environment, required skills, and the like. In some examples, these attributes can be updated by processing data received from various sensors deployed in the workplace. For example, a patrol service provider can receive sensor data from the sensors deployed in the target patrol areas, and the machine learned models utilized by the patrol service provider can generate the training data based on the processing results of the sensor data. In some examples, the set of additional inputs includes a set of target areas, and each target area includes one or more sub-areas.

At block 408, the automated training service 114 generates one or more workflows for each of the plurality of sub-areas. In some examples, each workflow of the one or more workflows includes attributes comprising time data and location data associated with corresponding sub-area. In some examples, the attributes of each workflow includes a set of hierarchical data, and the hierarchical data include a plurality of layers, where each layer associated with one or more assigned manifests. In some cases, the location data of the workflows include patrol areas such that a top level of the hierarchical data is a master plan for patrolling the patrol areas, having a plurality of posts, and a lower level of the hierarchical data is a patrolling plan of each post of the plurality of posts. The patrolling plan can include a number of demanded employees and demanded time duration for patrolling corresponding post. In some examples, the attributes of the workflow can further include demanded duty and skills of employee to perform the master plan for patrolling corresponding post.

In some examples, the machine learning component 216 (shown in FIG. 2) can include a neural network model. The neural network model is configured to dynamically update the workflows. In some examples, the neural network model is configured to collect a set of sensor data from a plurality of sensors operatively coupled with the automated training service, apply the collected set of sensor data to the workflows to the neural network model, and generate updated workflows as results of the application of the collected set of sensor data to the workflows. In some cases, the neural network model is further configured to create a training set comprising the workflows, the collected set of sensor data, and the updated workflows such that the neural network model is continuously trained by using the training set. The machine learning component 216 can also be configured to dynamically generate the training instructions by utilizing the created training set. In some cases, the set of sensor data includes temperature sensors, object detection sensors, gas sensors, image sensors, and radar sensors.

In some embodiments, the machine learning component 216 is configured to generate a plurality of training scenarios by modifying one or more sensor data of the collected set of sensor data, applying the modified one or more sensor data to the neural network model, and generating the plurality of training scenarios based on the modified one or more sensor data and results of applying the modified one or more sensor data.

At block 410, the automated training service 114 generates filtering criteria for each workflow. In some examples, the filtering criteria can include time data and location data such that the time data and location data of each workflow can be filtered by utilizing the filtering criteria, such as the time and location data of the filtering criteria.

At block 412. the automated training service 114 filter the set of inputs of each workflow based on the filtering criteria. For example, the geometry identifiers and the time identifiers of the plurality of computing devices are filtered based on the time data and the location data, respectively, of the criteria such that each sub-area is associated with one or more workflows, where each workflow of the one or more workflows is associated with identifications of computing devices, corresponding to the filtered set of inputs.

At block 414, the automated training service 114 generates training instructions. In various examples, the training instructions can be provided as the questionnaire. For example, when the employee is prepared to initiate work, the automated training service 114 can automatically generate the questions (as the training instructions in accordance with one or more embodiments disclosed herein) and provide these questions to the employee by displaying the questions on the display of the computing device. The present disclosure does not limit the number of questions.

In some embodiments, the automated training service 114 generates training instructions by obtaining a set of manifests associated with each workflow from the database 150. For example, the database is configured to store a plurality of workflows and sets of manifests associated with each workflow.

In some embodiments, the automated training service 114 can generate training instructions based on the workflows of each employee. In various examples, the automated training service 114 can generate a plurality of training instructions associated with the workflow. In these examples, the automated training service 114 can utilize the machine learning component 216 to generate the plurality of training instructions. For example, the machine learning component 216 by utilizing its machine learned models can generate the training instructions in a plurality of scenarios. For instance, the machine learning component 216 utilized by a security patrol service provider can determine the plurality of scenarios associated with the workflow and generate the training instructions based on these scenarios. The generated plurality of training instructions can be stored in the database 150 of the network service provider 110.

In some embodiments, the automated training service 114 can prioritize the generated instructions based on priority. For example, each training instruction can have its weight that represent the level of the priority. In these embodiments, the automated training service 114 can provide the one or more training instructions to the employee via the computing device by filtering the generated training instructions based on the priority criteria. Further in these embodiments, the weight of each training instruction can be dynamically changed based on the current working environment and/or employee's profile.

In various embodiments, the automated training service 114 can further process the generated training instructions based on employee's profile information. In some examples, the profile information corresponds to the employee's attributes, such as rank (and associated duty), skills, performance history when executing the duty, previous evaluation data, training history of the employees, and the like. This profile information is stored in the database 150 and constantly updated. For example, the employee's evaluation data can be constantly updated as new evaluation data are generated. Furthermore, the employee's rank can be updated as the employee is promoted.

In some cases, the training instructions can be updated based on these employee's profile information. For example, in accordance with the employee's level of experience or skills, the training instructions can be provided with variance to each employee. In addition, each weight of the training instruction can be varied based on the employee's profile information. Thus, the automated training service 114 can provide customized (or updated) training instructions to each employee by dynamically adapting its instructions based on each employee's profile.

In various examples, the automated training service 114 can further update the training instructions based on the working environment information. For example, if a previous security patrol officer discovered a broken window at a post area, the instructions on the post area can be updated to train the following patrol officer in a scenario of discovering broken windows. In this example, the priority related to the scenario that discovering the broken windows can have a higher weight (e.g., higher priority). Thus, the automated training service 114 can dynamically update its training instructions based on the current working environments.

In some examples, the automated training service 114 can provide the training instructions to the employee by further filtering the generated training instructions based on the workflows. For example, the automated training service 114 can filter the training instructions by utilizing one or more criteria defined based on one or more attributes of the employee's profile. For example, the automated training service 114 can filter the training instructions based on employee's level of experience and/or skills. In addition, the automated training service 114 can also filter the training instructions based on one or more attributes defined from the working environment. For example, if a previous employee reported an incident, then the automated training service 114 can filter the training instructions to identify instructions related to the reported incident.

In addition, the automated training service 114 can modify or update the generated training instructions when one or more workflows are changed. For example, if the workflows are related to the security patrol service and that the workflows are changed due to the updated security patrol service contract (e.g., updated security patrol requirements), the automated training service 114 can automatically update the existing training instructions.

In some embodiments, to ensure the training of the employee, the automated training service 114 can provide the same type of training instructions in various scenarios. Thus, the knowledge of the employee can be ensured by answering the same type of training instructions in these scenarios.

In some cases, the automated training service 114 can utilize ML/AI component to generate the training instructions or scenarios automatically. In addition, the automated training service 114 can generate additional scenarios upon determining that the employee needs to perform instructions regarding the additional scenarios before performing duty. For example, if the employee's answer regarding the initial scenarios did not meet the threshold score, the automated training service 114 may generate additional training scenarios.

At block 416, the automated training service 114 transmits the generated training instructions to the computing device 102. For example, the automated training service 114 transmits, for each workflow, the generated training instructions associated with each workflow to corresponding computing device such that the corresponding computing device can have the identifications associated with the workflow. In some examples, these instructions can be displayed on the computing device.

At block 418, the automated training service 114 receives the answers to these questions, where the answers are provided by the employee associated with the computing device 102. In some cases, the automated training service 114 provides the training scenarios with acceptable answers (or a range of acceptable answers). In some examples, these training scenarios can be provided in a certain sequence or randomly. In some cases, these training scenarios can be provided once or recurrently.

At block 420, the automated training service 114 analyzes the obtained answers to verify whether the employee can initiate the work. In some examples, the automated training service 114 can verify based on the threshold number of correct answers. In some embodiments, the automated training service 114 can only verify if the answer(s) are correct. For example, the employee might be required to correctly answer those questions associated with high priority training instructions (weight of the instructions). In some examples, the automated training service 114 can provide further additional instructions if the employee was not verified. In some cases, the automated training service 114 can score each employee's performance on taking the training scenarios and store the score in the database as profile information for the employee. The routine 400 is ended at block 422. Although the operations of the routine 400 are described in a particular order, it should be understood that the routine 400 is not limited as such. Operations of the routine 400 may be performed in an alternative order, serially, or at least partially in parallel. Further, certain operations may not need to be performed.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be fully automated via software code modules, including one or more specific computer-executable instructions executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of customer computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable customer computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without customer input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code that include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed:

1. A system for dynamically generating employee training instructions in network-based services, the system comprising:
one or more computing devices associated with a processor and a memory for executing computer-executable instructions to implement an automated training service, wherein the automated training service is configured to:
obtain a set of inputs from a plurality of computing devices, wherein the set of inputs comprises geometry identifiers and time identifiers of each of the plurality of computing devices;
obtain a set of additional inputs from a database communicatively coupled with the automated training service, the set of additional inputs comprising a set of target areas, each target area comprising a plurality of sub-areas;
generate one or more workflows for each of the plurality of sub-areas, each workflow of the one or more workflows comprises attributes comprising time data and location data;
generate, for each workflow, filtering criteria, having the attributes;
filter, for each workflow, the set of inputs based on the filtering criteria by filtering the geometry identifiers and the time identifiers of the plurality of computing devices based on the time data and the location data of the criteria such that each sub-area is associated with one or more workflows, each workflow of the one or more workflows associated with identifications of computing devices, corresponding to the filtered set of inputs;
generate, for each workflow, one or more training instructions by obtaining a set of manifests associated with each workflow from the database, wherein the database is configured to store a plurality of workflows and sets of manifests associated with each workflow; and
transmit, for each workflow, the generated training instructions associated with each workflow to one or more computing devices, having the identifications associated with each workflow.

2. The system of claim 1, wherein the attributes of each workflow comprises a set of hierarchical data, the hierarchical data comprising a plurality of layers, each layer associated with one or more assigned manifests.

3. The system of claim 2, wherein the location data of the workflows include patrol areas, wherein a top level of the hierarchical data is a master plan for patrolling the patrol areas, having a plurality of posts, wherein a lower level of the hierarchical data is a patrolling plan of each post of the plurality of posts, and wherein the patrolling plan comprises number of demanded employees and demanded time duration for patrolling corresponding post.

4. The system of claim 3, wherein attributes of the workflow further comprise demanded duty and skills of employee to perform the master plan for patrolling corresponding post.

5. The system of claim 1, wherein the memory stores a machine learning component, the machine learning component including a neural network model configured to dynamically update the workflows, wherein the neural network model is configured to:
collect a set of sensor data from a plurality of sensors operatively coupled with the automated training service,
apply the collected set of sensor data to the workflows to the neural network model, and
generate updated workflows as results of the application of the collected set of sensor data to the workflows.

6. The system of claim 5, wherein the neural network model is further configured to create a training set comprising the workflows, the collected set of sensor data, and the updated workflows, wherein the neural network model is continuously trained by using the training set.

7. The system of claim 6, wherein the machine learning component is further configured to dynamically generate the training instructions by utilizing the created training set.

8. The system of claim 5, wherein the set of sensor data comprises temperature sensors, object detection sensors, gas sensors, image sensors, and radar sensors.

9. The system of claim 5, wherein the machine learning component is configured to generate a plurality of training scenarios by modifying one or more sensor data of the collected set of sensor data, applying the modified one or more sensor data to the neural network model, and generating the plurality of training scenarios based on the modified one or more sensor data and results of applying the modified one or more sensor data.

10. The system of claim 1, wherein the automated training service is further configured to authenticate the computing device by receiving an application program interface token from the plurality of computing devices and verifying the received application program interface token.

11. The system of claim 1, wherein the automated training service is further configured to receive answers to the generated training instructions from the one or more computing devices, having the identifications associated with each workflow, and filter the one or more computing devices, having the identifications associated with each workflow by verifying the received answers.

12. A system for dynamically generating employee training instructions in network-based services, the system comprising:
one or more computing devices associated with a processor and a memory for executing computer-executable instructions to implement an automated training service, wherein the automated training service is configured to:
obtain a set of additional inputs from a database communicatively coupled with the automated training service, the set of additional inputs comprising a set of target areas, each target area comprising a plurality of sub-areas;
generate one or more workflows for each of the plurality of sub-areas, each workflow of the one or more workflows comprises attributes comprising time data and location data;
generate, for each workflow, one or more training instructions by obtaining a set of manifests associated with each workflow from the database, wherein the database is configured to store a plurality of workflows and sets of manifests associated with each workflow;
transmit, for each workflow, the generated training instructions associated with each workflow to target computing devices communicatively coupled with the automated training service.

13. The system of claim 12, wherein the attributes of each workflow comprises a set of hierarchical data, the hierarchical data comprising a plurality of layers, each layer associated with one or more assigned manifests.

14. The system of claim 13, wherein the location data of the workflows include patrol areas, wherein a top level of the hierarchical data is a master plan for patrolling the patrol areas, having a plurality of posts, wherein a lower level of the hierarchical data is a patrolling plan of each post of the plurality of posts, and wherein the patrolling plan comprises number of demanded employees, and demanded time duration for patrolling corresponding post.

15. The system of claim 12, wherein the memory stores a machine learning component, the machine learning component including a neural network model configured to dynamically update the workflows, wherein the neural network model is configured to:
collect a set of sensor data from a plurality of sensors operatively coupled with the automated training service,
apply the collected set of sensor data to the workflows to the neural network model, and
generate updated workflows as results of the application of the collected set of sensor data to the workflows.

16. The system of claim 15, wherein the neural network model is further configured to create a training set comprising the workflows, the collected set of sensor data, and the updated workflows, wherein the neural network model is continuously trained by using the training set.

17. The system of claim 16, wherein the set of sensor data comprises temperature sensors, object detection sensors, gas sensors, and image sensors, radar sensors.

18. The system of claim 16, wherein the machine learning component is configured to generate a plurality of training scenarios by modifying one or more sensor data of the collected set of sensor data, applying the modified one or more sensor data to the neural network model, and generating the plurality of training scenarios based on the modified one or more sensor data and results of applying the modified one or more sensor data.

19. The system of claim 12, wherein the target computing devices are associated with employees pre-assigned to each workflow.

20. A method for dynamically generating employee training instructions in network-based services, the method comprising:
obtaining a set of inputs from a plurality of computing devices, wherein the set of inputs comprises geometry identifiers and time identifiers of each of the plurality of computing devices;
obtaining a set of additional inputs from a database, the set of additional inputs comprising a set of target areas, each target area comprising a plurality of sub-areas;
generating one or more workflows for each of the plurality of sub-areas, each workflow of the one or more workflows comprises attributes comprising time data and location data;
generating, for each workflow, filtering criteria, having the attributes;
filtering, for each workflow, the set of inputs based on the filtering criteria by filtering the geometry identifiers and the time identifiers of the plurality of computing devices based on the time data and the location data of the criteria such that each sub-area is associated with one or more workflows, each workflow of the one or more workflows associated with identifications of computing devices, corresponding to the filtered set of inputs;
generating, for each workflow, one or more training instructions by obtaining a set of manifests associated with each workflow from the database, wherein the database is configured to store a plurality of workflows and sets of manifests associated with each workflow; and
transmitting, for each workflow, the generated training instructions associated with each workflow to one or more computing devices, having the identifications associated with each workflow.
